(19) United States
(12) Patent Application Publication
(10) Pub. No.: US 2010/0326804 A1
(43) Pub. Date: Dec. 30, 2010

(54) Hand-held power tool

(76) Inventor: Dietmar Saur, Gomaringen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/801,823

(22) Filed: Jun. 28, 2010

(30) Foreign Application Priority Data
Jun. 30, 2009 (DE) 10 2009 027 317.4

(51) Int. Cl. H01H 9/06

(52) U.S. Cl. 200/332.2

(57) ABSTRACT

A tool, in particular a hand-held power tool, having an actuating unit that has at least one set of input electronics and at least one actuating element. The input electronics are mechanically coupled to the actuating element according to the invention.

### CROSS-REFERENCE TO RELATED APPLICATION

This application is based on German Patent Application 10 2009 027 317.4 filed Jun. 30, 2009.

### BACKGROUND OF THE INVENTION

1. Field of the Invention

The invention is based on a tool, in particular to a hand-held power tool.

2. Description of the Prior Art

A tool, in particular a hand-held power tool, having an actuating unit equipped with at least one set of input electronics and at least one actuating element, has already been proposed.

### OBJECT AND SUMMARY OF THE INVENTION

The invention is based on a tool, in particular a hand-held power tool, having an actuating unit equipped with at least one set of input electronics and at least one actuating element.

According to one proposal, the input electronics are mechanically coupled to the actuating element. An “actuating unit” should in particular be understood to be a unit that is provided to permit the user to influence at least one element of the tool. Preferably, the actuating unit permits the user to influence a motor, a measurement sensor, a heating system, and/or another element of the tool deemed suitable by the person skilled in the art. The term “provided” should in particular be understood to mean specially equipped, embodied, and/or programmed. In particular “input electronics” should be understood to be electronics that determine or detect at least one input of a user. The term “electronics” should in particular be understood to be an element that influences a behavior of at least one electrical current in a semiconductor. The electronics advantageously include at least one transistor. Preferably, the input electronics are embodied in the form of a circuit board equipped with at least one component. An “actuating element” should in particular be understood to be a movable element of the actuating unit. The actuating element can be advantageously moved by the user, preferably in relation to a tool housing. The actuating element is advantageously embodied in the form of a catch, but could also be embodied in the form of a switch, a button, a rotary switch, and/or another actuating element deemed suitable by the person skilled in the art. The term “mechanically coupled” should in particular be understood to mean connected to the actuating element in a mechanically fixed, mechanically elastic and/or shock-absorbing fashion. The expression “elastic and/or shock-absorbing” should in particular be understood to mean slightly movable in relation to the actuating element. The term “slightly” should in particular be understood to mean at most 25%, preferably at most 10%, of the distance that the actuating element can be moved in relation to the tool housing. Preferably, the input electronics are detent-connected, glued, encapsulated with, screw-connected, and/or clamped to the actuating element, and/or attached to it in some other way deemed suitable by the person skilled in the art. A “tool” should in particular be understood to mean all tools deemed suitable by the person skilled in the art such as stationary tools, e.g. circular table saws, planes, measuring instruments, and/or particularly advantageously, hand-held tools. Examples of a hand-held tool include a screwdriver, a drill, a rotary hammer and/or chisel hammer, a saw, a plane, a grinder, a multifunction tool, a hand-held measuring instrument, and/or any other hand-held tool deemed suitable by the person skilled in the art. Examples of a measuring instrument or hand-held measuring instrument include a position finder, a distance measuring device, and/or another measuring instrument or hand-held measuring instrument deemed suitable by the person skilled in the art. Preferably, the measuring instrument or hand-held measuring instrument determines the measured value.

The embodiment according to the invention makes it possible to achieve an advantageous integration of the input electronics and in particular, the input electronics can easily be at least partially coupled from a tool housing, achieving an advantageous protection of the input electronics from external forces. In addition, an inexpensive manufacture of the tool is achieved because the actuating element can be preassembled with the input electronics, making it unnecessary to provide a separate shock-absorbing installation site for the input electronics.

In an advantageous proposed embodiment of the invention, the input electronics are integrated into the actuating element. The term “integrated” should in particular be understood to mean at least partially accommodated in the actuating element. In particular, the input electronics are at least partially, advantageously up to at least 90%, particularly advantageously completely, situated in a space inside the actuating element. For example, the space is embodied in the form of a cavity and/or space that is at least partially, preferably completely, filled with casting compound. The term “inside” should in particular be understood to mean within an outer contour of the actuating element. The fact that the input electronics are integrated into the actuating element makes it possible to achieve a particularly compact embodiment of the tool, permitting an advantageously small grip diameter.

In another proposed embodiment, the input electronics include at least one control electronics component. A “control electronics component” should in particular be understood to be a component that enables at least one control of an element of the tool. Preferably, the control electronics component is embodied in the form of an active component—in a particularly preferable embodiment, a microcontroller. The control electronics component advantageously evaluates at least one setting or position of the actuating element in relation to the tool housing. In addition, the control electronics component is advantageously provided to determine and/or limit at least a speed, a torque, and/or a measurement value of the tool. For example, a measurement value is a directly measurable measurement value such as a temperature, a length, an angle, and/or a path and/or an indirectly measurable measurement value such as a position, a humidity, a slope, a current, a capacitance, a voltage, and/or the presence of an object. The control electronics component of the input electronics can be used to achieve an advantageous, active control and/or regulation of the tool.

According to another proposal, the control electronics component is integrated into the actuating element, permitting the control electronics component, like the input electronics, to easily be at least partially decoupled from a tool housing or integrated into it in a shock-absorbing fashion, thus making it possible to protect it from mechanical influences acting on the tool housing.

According to another proposal, the control electronics component is provided to control a control variable. A “control variable” should in particular be understood to mean a control variable deemed suitable by the person skilled in the art and/or in particular, a speed and/or torque of a motor. The verb “to control” should in particular be understood to also mean “to regulate”. Controlling the speed and/or torque makes it possible to achieve a particularly convenient and safe maneuvering of the tool by the user.

According to another proposal, the actuating unit has at least one coupling element that movably fastens the actuating element. Preferably, the coupling element movably fastens the actuating element at least to a tool housing. The expression “movably fastens” should in particular be understood to mean a fastening that permits a pivoting, sliding, and/or rotating motion in relation to the tool housing. The coupling element makes it possible to anchor the actuating element in a stable, precise fashion in the tool housing, enabling a rugged construction; in particular, the coupling element makes it possible to achieve an advantageous indirect support of the electronics component via the actuating element. The coupling element advantageously attaches the actuating element in an at least partially elastic and/or shock-absorbing fashion, which achieves a particularly advantageous decoupling between the tool housing and the actuating element, thus in turn protecting the input electronics from mechanical damage.

In an advantageous proposed embodiment of the invention, the actuating unit has a return device that is provided to move the actuating element toward a starting position after an actuation. The term “actuation” should in particular be understood to mean a movement of the actuating element by the user. The term “starting position” should in particular be understood to be a position of the actuating element before the user actuates the actuating element, i.e. when the user has not exerted a force on the actuating element. The return device permits the user to operate the tool in a convenient fashion, above all with one hand.

In another proposed embodiment, the input electronics include a sensor element that is provided to determine a position of the actuating element. The sensor element is advantageously integrated into the actuating element. A “sensor element” should in particular be understood to be an element and/or component that records or determines a piece of information about a position of the actuating element. The sensor element advantageously has a capacitive, magnetic, and/or mechanical sensor for determining the position. The sensor element preferably emits the information about a position of the actuating element in the form of an electrical signal. Preferably, the control electronics component records this signal. A “position of the actuating element” should in particular be understood to be an orientation and/or position in relation to a tool housing. Preferably, a user changes the position of at least one actuating element when actuating it. The input electronics can advantageously use the sensor element to carry out a control as a function of a position of the actuating element.

According to another proposal, the input electronics include at least one integrated circuit. An “integrated circuit” should in particular be understood to be at least one electronic circuit accommodated on at least one semiconductor. The control electronics component is advantageously embodied in the form of an integrated circuit. The presence of an integrated circuit makes it possible to advantageously achieve a particularly inexpensive, flexible control.

According to another proposal, the input electronics are at least partially encapsulated in the actuating element. The expression “at least partially encapsulated” should in particular be understood to mean that the input electronics are at least partially accommodated in a space that is filled with a casting material and/or injection-molding compound. This material is advantageously molten or fluid when being processed during a manufacturing process. In a particularly advantageous embodiment, this material is elastic and/or solid after processing. In this case, the input electronics can be at least partially inserted into a cavity of the actuating element, which is then filled with casting compound and/or can advantageously be cast and/or injection-molded into the actuating element as part of its manufacturing process. An encapsulation of the input electronics permits them to be integrated into the actuating element so that they are advantageously protected from dust and moisture. In addition, the encapsulation can achieve an additional decoupling and in particular, a shock-absorption and/or vibration damping.

According to another proposal, a set of power electronics with an interface is provided, which is connected to the input electronics. An “interface” should in particular be understood to be a path via which information can be transmitted. Preferably, the path is embodied in the form of an electrical line, an inductive coupling, a capacitive coupling, and/or a radio link. The provision of the interface makes it possible to achieve a compact electrical connection, e.g. an individual cable with plugs, between the actuating element and the rest of the tool, thus permitting a particularly simple assembly.

An advantageous embodiment of the invention includes a proposed tool housing into which the power electronics are integrated. The power electronics are advantageously situated at least partially, preferably up to 80%, particularly preferably completely, in a space inside the tool housing. For example, the space is embodied in the form of a cavity or in the form of a space that is at least partially, preferably completely, filled with a casting compound. The power electronics are advantageously connected to the tool housing at least in a mechanically elastic and/or shock-absorbing and/or mechanically fixed fashion. It is possible to achieve an advantageously protected arrangement of the power electronics and in particular, it is possible for an electrical connection between a rechargeable battery connecting device of the tool and a motor of the tool to be embodied in a particularly short and therefore low-loss way. In addition, the power electronics can be cooled by an air flow of the motor.

According to another proposed embodiment, the input electronics control a speed and/or torque of a motor by means of the power electronics, as a result of which the input electronics require an advantageously small amount of space.

### BRIEF DESCRIPTION OF THE DRAWING

The invention will be better understood and further objects and advantages thereof will become more apparent from the ensuing detailed description of preferred embodiments taken in conjunction with the drawing, in which:

FIG. 1 is a partially sectional depiction of a tool according to the invention.

### DESCRIPTION OF THE PREFERRED EMBODIMENTS

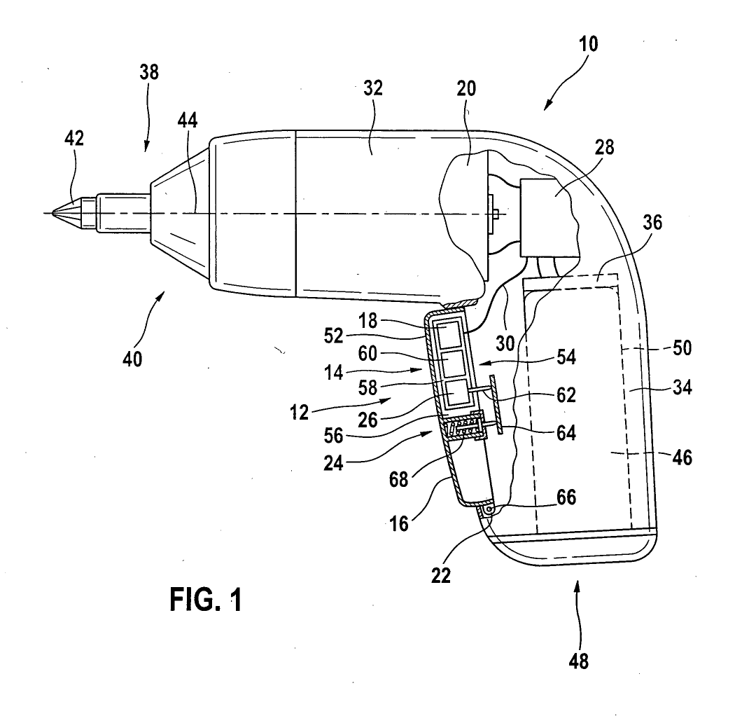

FIG. 1 shows a tool 10, which is embodied in the form of a hand-held power tool, namely a cordless screwdriver. The tool 10 has an actuating unit 12, a set of power electronics 28, a pistol-shaped tool housing 32 with a main handle 34, a rechargeable battery connecting device 36, and a tool holding device 38. The tool holding device 38 is situated at a front end 40 of the tool 10 remote from the rechargeable battery connecting device 36. An insert tool 42 embodied in the form of a Phillips bit is mounted in the tool holding device 38. The insert tool 42 and the tool holding device 38 can be driven to rotate around a tool rotation axis 44 by a motor 20 of the tool 10. The motor 20 is situated on the tool rotation axis 44 between the power electronics 28 and the tool holding device 38. The tool holding device 38 is connected to the motor 20 via a transmission that is not shown in detail.

In an operational state shown in the drawing, the rechargeable battery connecting device 36 is connected to a rechargeable battery 46 of the tool 10. The rechargeable battery connecting device 36 is situated at a rear end 48 of the tool 10 remote from the tool holding device 38, in a battery insertion region 50 of the tool 10, beneath the power electronics 28. Furthermore, the rechargeable battery 46 is inserted into the battery insertion region 50 situated inside the main handle 34 and can be removed and replaced by user, not shown in detail, without tools. At an end of the rechargeable battery connecting device 36 oriented toward the tool rotation axis 44, the rechargeable battery 46 is connected to the rechargeable battery connecting device 36 in an electrically conductive and mechanical fashion. Alternatively, the rechargeable battery can be integrated into the tool permanently, i.e. cannot be removed without tools or in a non-destructive fashion.

The actuating unit 12 is situated on the main handle 34, oriented toward the insert tool 42, next to the battery insertion region 50. The actuating unit 12 has an actuating element 16 and a set of input electronics 14. The actuating element 16 is embodied in the form of a pushbutton catch. The actuating element 16 has a shell-shaped base body 52. An open side 54 of the actuating element 16 or base body 52 is oriented toward the battery insertion region 50. The input electronics 14 are mechanically coupled to the actuating element 16. The input electronics 14 are integrated into a space 56 delimited by the shell-shaped base body 52; in fact, the input electronics 14 are situated completely inside the space 56. After the input electronics 14 are inserted into the space 56 during a manufacturing process, the space 56 is filled with a plastic not shown here. The plastic is electrically insulating and in order to absorb shocks, is elastic and therefore shock-absorbing when in a processed, hardened state.

The input electronics 14 include a control electronics component 18, a sensor element 26, a circuit support 58, and an additional component 60. The control electronics component 18 is embodied in the form of a microcontroller and is soldered to the circuit support 58. The input electronics 14 thus include an integrated circuit. The input electronics 14 are almost completely encased in plastic, i.e. except for the functionally required openings. Proper function requires an opening for the sensor element 26 and an opening for an interface 30. The control electronics component 18 and the circuit support 58 are thus encapsulated and integrated into the actuating element 16. The additional component 60 is embodied in the form of a voltage supply component for the control electronics component 18.

A control program is stored in a memory, not shown in detail, of the control electronics component 18. The control program evaluates information from the sensor element 26 about a position of the actuating element 16. Based on this information, the control program and the microcontroller control the power electronics 28 and thus a speed and/or torque of the motor 20 of the tool 10. The sensor element 26 determines a position of the actuating element 16. For this purpose, the sensor element 26 has a mechanical or tactile feeler 62 that determines a distance between the sensor element 26 and a stop element 64 of the tool housing 32.

The actuating unit 12 also has a coupling element 22 and a return device 24. The coupling element 22 fastens the actuating element 16 so that it is able to pivot around an axis and move in relation to the tool housing 32. This axis is perpendicular to the tool rotation axis 44 and perpendicular to a main span of the actuating unit 12. The coupling element 22 is embodied in the form of an eyelet that is embodied as integral to the actuating element 16. The eyelet is engaged by a pin 66 of the tool housing 32. Other guide elements of the actuating unit 12, which are not shown in detail, guide the actuating element 16 during its actuation by the user.

After an actuation by the user, the return device 24 moves the actuating element 16 toward a starting position of the actuating element 16, i.e. in a direction oriented away from the battery insertion region 50. The return device 24 has a return spring 68 and rests against the stop element 64. The return spring 68 provides shock-absorption for the actuating element 16 in a direction parallel to the tool rotation axis 44. During an actuation of the actuating element 16, the actuating element 16 is held in a position in a shock-absorbing fashion by forces of the return spring 68 and by forces of a user's finger, not shown. The input electronics 14 are consequently protected from vibrations having a force direction parallel to the tool rotation axis 44. It is possible to provide other shock-absorbing measures, not shown in detail, deemed suitable by the person skilled in the art to protect the actuating element 16 in other directions. The return device 24 also acts as a stop for the actuating element 16. In other words, the return device 24 limits a distance that the user can move the actuating element 16 toward the battery insertion region 50.

The power electronics 28 are situated on a side of the motor 20 remote from the tool holding device 38, next to the battery insertion region 50, and are integrated into the tool housing 32. The power electronics 28 here are connected to the tool housing 32 and the motor 20 in a mechanically shock-absorbing fashion. The power electronics 28 include the interface 30 that is connected to the input electronics 14 of the actuating unit 12. By means of this interface 30, the input electronics 14 and the control electronics component 18 control the power electronics 28 and thus the speed and/or torque of the motor 20. The interface 30 is embodied in the form of a multiwire cable equipped with a plug that is not shown in detail.

The foregoing relates to preferred exemplary embodiments of the invention, it being understood that other variants and embodiments thereof are possible within the spirit and scope of the invention, the latter being defined by the appended claims.

1. A tool, in particular a hand-held power tool, having an actuating unit that has at least one set of input electronics and at least one actuating element, wherein the input electronics are mechanically coupled to the actuating element.

2. The tool as recited in claim 1, wherein the input electronics are integrated into the actuating element.

3. The tool as recited in claim 1, wherein the input electronics include at least one control electronics component.

4. The tool as recited in claim 2, wherein the input electronics include at least one control electronics component.

5. The tool as recited in claim 3, wherein the control electronics component is integrated into the actuating element.

6. The tool as recited in claim 4, wherein the control electronics component is integrated into the actuating element.

7. The tool as recited in claim 3, wherein the control electronics component is provided to control a control variable.

8. The tool as recited in claim 4, wherein the control electronics component is provided to control a control variable.

9. The tool as recited in claim 5, wherein the control electronics component is provided to control a control variable.

10. The tool as recited in claim 6, wherein the control electronics component is provided to control a control variable.

11. The tool as recited in claim 1, wherein the actuating unit has at least one coupling element that movably fastens the actuating element.

12. The tool as recited in claim 1, wherein the actuating unit has a return device that is provided to move the actuating element toward a starting position after an actuation.

13. The tool as recited in claim 1, wherein the input electronics include a sensor element that is provided to determine a position of the actuating element.

14. The tool as recited in claim 1, wherein the input electronics include at least one integrated circuit.

15. The tool as recited in claim 1, wherein the input electronics are at least partially cast into the actuating element.

16. The tool as recited in claim 1, further having a set of power electronics equipped with an interface that is connected to the input electronics.

17. The tool as recited in claim 16, further having a tool housing relative to which the power electronics are immovably situated.

18. The tool as recited in claim 16, wherein the input electronics control a speed and/or torque of a motor by means of the power electronics.

19. The tool as recited in claim 17, wherein the input electronics control a speed and/or torque of a motor by means of the power electronics.

20. An actuating element with a coupled set of input electronics for a tool as recited in claim 1.
